(19) United States
(12) Patent Application Publication
(10) Pub. No.: US 2024/0062316 A1
(43) Pub. Date: Feb. 22, 2024

(54) COMMENTING ENTITLEMENT SYSTEM WITHIN AN ONLINE SOCIAL NETWORKING PLATFORM UTILIZING REAL-IDENTIFICATION VERIFICATION AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/452,801

(22) Filed: Aug. 21, 2023

Related U.S. Application Data
(60) Provisional application No. 63/400,042, filed on Aug. 22, 2022.

(51) Int. Cl. G06Q 50/00; G06F 21/62; G06F 21/60

(52) U.S. Cl. CPC G06Q 50/01; G06F 21/6218; G06F 21/602; G06F 2221/2141

(57) ABSTRACT

The disclosed invention relates to a commenting entitlement system (100) within an online social networking platform (101), leveraging real-ID verification for enhanced user interactions. The system (100) comprises a real ID setup module (102) that streamlines real-ID verification during user registration, fortifying identity authenticity. Furthermore, the system (100) incorporates a commenting module (103) permitting users with verified real IDs to engage in diverse interaction activities on the online social networking platform (101). Additionally, a user ‘hash’ generation module (104) is integrated, producing a distinct user ‘hash’ that anonymously correlates real IDs with corresponding user profiles, ensuring confidential connections and a multi-account prevention module (105) is integrated, constraining engagement across multiple accounts using identical real ID-based user ‘hashes.’

### CROSS-REFERENCE TO RELATED APPLICATIONS

This application claims priority from U.S. provisional application Ser. No. 63/400,042 filed on 22 Aug. 2022 entitled “METHODS AND SYSTEMS OF ONLINE SOCIAL NETWORKING”, herein the entirety is incorporated by reference.

### DESCRIPTION OF THE INVENTION

### Technical Field of the Invention

The present invention pertains to the field of commenting and engagement functionalities within the realm of an online social networking platform, along with the corresponding methodology. More particularly, the invention relates to a system featuring a real-Identification (real-ID) verification mechanism designed to establish a user authenticity through the mapping of the real-ID embedded within the interface of the platform. The verification framework provides eligible users with the right to partake in commenting and interacting with other users within the platform. The invention also discloses a method for ensuring the authenticity and accountability of user interactions within an online social networking platform utilizing real-ID verification.

### BACKGROUND OF THE INVENTION

The emergence of online social networking platforms has indubitably redefined the paradigm of connecting individuals, disseminating information, and fostering global interactions. Nonetheless, as these platforms persistently evolve and adapt to accommodate an expanding user constituency, specific inadequacies have become apparent, necessitating the exploration of novel solutions.

One of the predominant challenges pertains to the preservation of user authenticity and accountability within online social networking platforms. Within numerous prevailing platforms, users are granted the ability to establish accounts employing pseudonyms or fictitious identities, thereby engendering an environment wherein detrimental behaviors can transpire devoid of repercussions. This absence of identity verification not only undermines the credibility of interactions but also incubates detrimental activities such as cyberbullying, trolling, and the propagation of misinformation.

Another prevailing concern pertains to the inadequacy in maintaining accountability. Users possess the capability to maneuver around bans or limitations by generating multiple accounts, thereby perpetuating disruptive actions without facing repercussions. This unrestricted potential to establish numerous identities undermines the platforms' ability to maintain a secure and safeguarded environment.

Further, issues pertaining to privacy and data security have gained prominence. Users often express apprehensions about the unauthorized exploitation of their personal data, resulting in a diminished level of trust in the capabilities of these platforms. The potential risks associated with data breaches and the mishandling of personal information further contribute to eroding user confidence in the platform's capacity to effectively safeguard their data.

Furthermore, these challenges can be effectively addressed through the implementation of innovative solutions. One such solution involves the incorporation of robust identity verification mechanisms during user registration, ensuring that each user's identity is authenticated through reliable methods. By integrating advanced encryption and authentication protocols, the platforms can establish a secure environment for data storage and transmission, assuaging users' concerns about data security. Currently, there is a need for a more sophisticated approach that not only elevates user authenticity but also nurtures a heightened sense of accountability within the online community.

The Patent Application No. US2013091581A1 titled “Methods and Systems for Establishing and Maintaining Verified Anonymity in Online Environments” pertains to an innovation in the realm of online communities and e-commerce platforms seeking to verify the identities of individuals. Traditionally, a verified user is constrained to a single user identity, typically their real name. However, the practicality of utilizing one's real name in online interactions and transactions is often suboptimal and, in certain cases, may even pose personal safety concerns. Additionally, certain transactions necessitate enhanced privacy measures. This invention introduces methods and systems enabling online users to establish and maintain verified anonymity. To achieve this, the process involves initial verification of the user's real identity. Subsequently, the user can create and manage one or more pseudonyms, each associated with their account. These pseudonyms can be selectively adopted by the user for use in the online realm, such as within an online social network or similar platforms.

The Patent Application No. WO2018124890A1, titled “Method for carrying out and administering self-updating universal identification of users of public and private communication systems and official or non-official online platforms that require unique user authentication for each user in all existing systems and platforms which is the same across all said systems and platforms for each user” pertains to an innovative approach encompassing both an identification system and an organizational method that truly aligns individuals' personal identity data with their obtained identification. Furthermore, this invention encompasses a comprehensive methodology for the application and utilization of this identification across various personal and business communication channels, ensuring secure authentication and identification processes. These techniques extend to even officially verifying virtual identities on a global scale. The method streamlines and automates the management and updating of individual and business data, including contact information, within both private domains and LAN networks, as well as public environments, WAN networks, state identification systems, and widespread communication systems. Moreover, the method ensures genuine user identification on electronic commerce platforms and in public or private establishments necessitating user authentication for service access.

In summation, despite the transformative impact of online social networking platforms on connectivity and communication, certain limitations endure. Hence, there arises a demand for a pioneering remedy capable of addressing the existing inadequacies pertaining to user authenticity and accountability in the context of online social networking platforms. These solutions hold the potential to substantially augment the user experience and play a pivotal role in advancing a more dynamic and enriching landscape within the domain of online social networking.

### SUMMARY OF THE INVENTION

The present invention overcomes the drawbacks of the prior art by disclosing a commenting entitlement system within an online social networking platform that integrates real-ID verification mechanisms to elevate user authenticity and engagement. The system encompasses crucial elements, notably a real-ID setup module that simplifies real-ID verification during the user registration, bolstering the credibility of user identities. Furthermore, the system incorporates a commenting module that confers engagement privileges to users with verified real-IDs, thereby enriching the user interactions. Moreover, the system includes a user ‘hash’ generation module, ensuring discreet linkage between the real IDs and the user profiles, thereby preserving confidentiality during correlation processes. Additionally, the system features a multi-account prevention module that restrains multiple account participation by associating identical real-ID based user ‘hashes,’ thereby fostering a secure and accountable virtual environment.

Further, the present invention discloses a method for enhancing the authenticity and accountability of user interactions within the online social networking platform through the utilization of real-ID verification. The method encompasses several steps that includes the establishment of authentic real-IDs during user registration, granting engagement rights to the users with verified real IDs, establishing a confidential linkage between the users' real-IDs and unique user ‘hashes’, and preventing the usage of multiple accounts for engagement activities through the interlinking of distinct user ‘hashes’ with their real-IDs. The method significantly improves the trustworthiness of user interactions, promotes secure and confidential correlations, and ensures a more credible and enriched online social networking environment.

The method ensures the genuine representation and accountability of users by incorporating real-ID verification during the user registration process, effectively minimizing the utilization of false identities and deterring malicious behaviors. Furthermore, the method's focus on exclusively extending engagement privileges to users possessing verified real-IDs aims to cultivate substantial interactions among authentic users, thereby diminishing the occurrence of spam, trolling, and disruptive conducts.

Further, the method safeguards users' privacy by avoiding the direct exposure of real-IDs, thereby establishing a confidential linkage between user profiles and their respective real-IDs. By proactively addressing concerns related to user authenticity and interaction quality, the method fosters an elevated level of trust among users, propelling more profound interactions and contributing to an optimally positive user experience.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing a commenting entitlement system within an online social networking platform utilizing real-ID verification.

FIG. 2 illustrates a flow diagram disclosing a method for ensuring the authenticity and accountability of user interactions within an online social networking platform utilizing real-ID verification.

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention. The terms “real-identification”, “real-ID” may be interchangeably used.

The present invention discloses a commenting entitlement system within the online social networking platform with real-ID verification, enhancing user credibility and engagement. The present invention comprises a real-ID setup module for easy verification during registration, a commenting module for verified users to comment and post, a discreet user ‘hash’ generation module, and a multi-account prevention module for a secure environment.

Further, the present invention discloses a method to enhance authenticity and accountability in online social networking by using real-ID verification. The method involves steps such as verifying real-IDs during registration, granting engagement rights to verified users, and preventing multi-account engagement. The method boosts interaction credibility, ensures secure correlations, and creates a trustworthy environment.

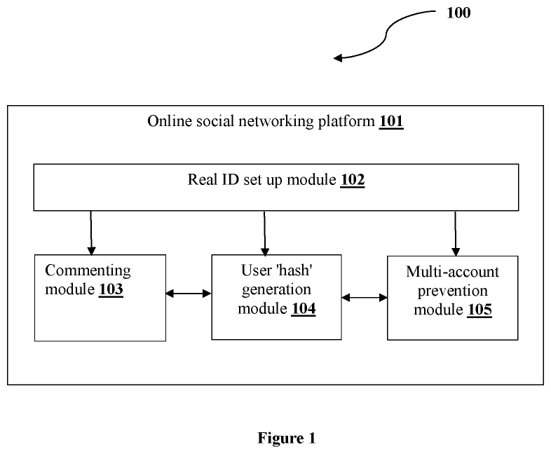

FIG. 1 illustrates a block diagram disclosing a commenting entitlement system within an online social networking platform utilizing real-ID verification. The system (100) comprises a real ID set up module (102) configured to facilitate a setup for a real-Identification (real-ID) verification during a registration process of multiple users within the online social networking platform (101), ensuring authenticity of the user identities. The user's verified real-ID serves as a basis for granting privileges to users to participate in multiple engagement activities. Further, the system (100) comprises a commenting module (103) configured to permit the users with a verified real ID to participate in one or more engagement activities within the online social networking platform (101). The verified-real ID is utilized by the commenting module (103) to determine user eligibility for engagement. More particularly, the users with verified real IDs are granted access to participate in the engagement activities. Further, the system (100) comprises a user ‘hash’ generation module (104) configured to generate a unique user ‘hash’, enabling an anonymous correlation between the real-ID and the corresponding user's profile, thereby providing confidentiality during the process of establishing correlation. The unique user ‘hash’ generated is associated with the verified real-ID. Furthermore, the system (100) comprises a multi-account prevention module (105) configured to curtail the engagement activities across multiple accounts associated with the users utilizing the identical real ID-based user ‘hash’.

In an embodiment of the present invention, the real-ID set up module (102) establishes the foundation by verifying user identities. Further, the commenting module (103) and the user ‘hash’ generation module (104) utilize this verified real-ID to allow eligible users to engage while maintaining anonymity. Furthermore, the multi account prevention module (105) enhances security by using the unique user ‘hash’ to prevent misuse of multiple accounts

In an embodiment of the present invention, the system (100) is configured to introduce a predetermined time delay prior to granting users the capability to participate in engagement activities. Additionally, the system (100) is tailored to oversee user interactions, subsequently conferring engagement privileges to users based on an aggregation of favorable interactions achieved over a predetermined time duration. Furthermore, the distinct user ‘hash’ generation module (103) within the system (100) employs an encryption technique to effectively establish and safeguard the anonymous association between the real-ID and corresponding users.

Furthermore, the system (100) optimizes the utilization of the user's device and location information to identify and prevent situations where identical real ID-based user ‘hashes’ are employed across multiple accounts. By ensuring distinct interactions for each user, the system (100) maintains the authenticity of user engagements and upholds the integrity of the online social networking environment.

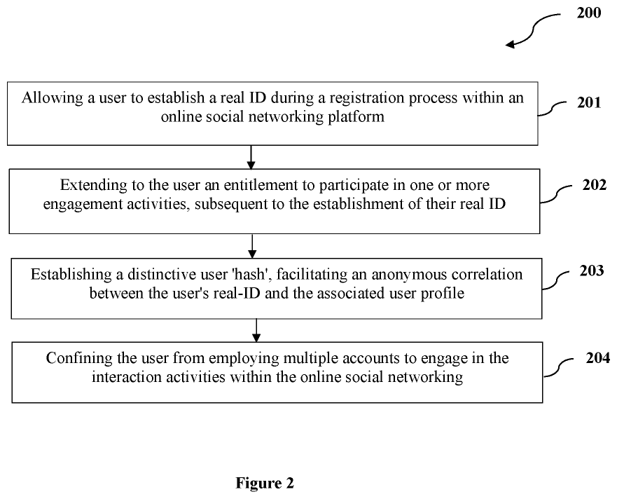

FIG. 2 illustrates a flow diagram disclosing a method for ensuring the authenticity and accountability of user interactions within an online social networking platform utilizing real-ID verification. The method (200) comprises the steps of allowing a user to establish a real ID during a registration process within an online social networking platform in step (201). In step (202), the user is granted the privilege to engage in one or more participation activities, following the successful establishment of their real ID. In step (203), a distinctive user ‘hash’, is established, facilitating an anonymous correlation between the user's real-ID and the associated user profile, thus ensuring confidentiality during correlation establishment process. Further, in step (204), the user is restricted from utilizing multiple accounts to partake in interaction activities within the online social networking platform, achieved by associating the unique user ‘hash’ with their real ID across diverse accounts.

In an embodiment of the present invention, the method (200) employs a cryptographic technique to generate the unique user ‘hash.’ The cryptographic approach guarantees the security and irreversibility of the correlation between the user's real ID and their corresponding profile. The use of cryptographic techniques ensures that the association between the real ID and the user remains secure and cannot be easily tampered with or deciphered by unauthorized parties. This enhances the confidentiality and reliability of the mapping process, contributing to the overall effectiveness of the method (200) in safeguarding user identities and interactions within the online social networking platform.

There are several advantages of the present invention in ensuring the authenticity and accountability of user interactions within an online social networking platform utilizing real-ID verification. This initial verification ensures that users are genuinely represented and significantly reduces the potential for harmful behaviors associated with false identities.

Further, another advantage of the present invention is that the method (200) extends an entitlement to users with verified real IDs to participate in engagement activities. Further, the method (200) promotes meaningful interactions and also fosters a more accountable online community. Users with verified real IDs are more likely to engage in positive interactions, contributing to an enriched and trustworthy social networking environment. Further, the method (200) aims at establishing an anonymous correlation between the user's real ID and a distinctive user ‘hash’. This unique user ‘hash’ provides a confidential link between the user's identity and profile. This confidentiality enhances privacy and prevents the direct exposure of real IDs while maintaining the authenticity of interactions.

Yet another advantage of the present invention lies in its capability to prevent users from employing multiple accounts to engage in interaction activities. This measure effectively discourages the misuse of multiple accounts for disruptive intentions, thereby cultivating a secure and accountable online atmosphere. Moreover, the method (200) promotes authentic interactions, curbs the prevalence of false identities, incentivizes positive conduct, and upholds user privacy. This amalgamation of advantages ultimately results in an elevated user experience and contributes to the cultivation of a more meaningful and productive online social networking environment.

TABLE 1
Reference numbers:

| Components | Reference Numbers |
|---|---|
| System | 100 |
| Online social networking platform | 101 |
| Real ID set up module | 102 |
| Commenting module | 103 |
| User ‘hash’ generation module | 104 |
| Multi-account prevention module | 105 |

We claim:

1. A commenting entitlement system within an online social networking platform utilizing a real-Identification (real-ID) verification, the system (100) comprising:
a. a real-Identification (real-ID) set up module (102) configured to facilitate a setup for real-Identification (real-ID) verification during a registration process of one or more users within the online social networking platform (101), ensuring authenticity of the user profiles;
b. a commenting module (103) configured to permit the users with a verified real ID to participate in one or more engagement activities within the online social networking platform (101);
c. a user ‘hash’ generation module (104) configured to generate a unique user ‘hash’, enabling an anonymous corelation between the real-ID and the corresponding user's profile, thereby providing confidentiality during the process of establishing corelations; and
d. a multi-account prevention module (105) configured to curtail the engagement activities across multiple accounts associated with the users utilizing the identical real ID-based user ‘hash’.

2. The system (100) as claimed in claim 1, wherein the system (100) is configured to implement a predetermined time delay before the users are permitted to participate in the engagement activities.

3. The system (100) as claimed in claim 1, wherein the system (100) is configured to monitor the user interactions and grant participation rights in the engagement activities to the users based on an aggregation of favourable interactions over a predetermined duration.

4. The system (100) as claimed in claim 1, wherein the unique user ‘hash’ generation module (103) employs an encryption technique to establish and secure the anonymous correlation between the real-ID's and corresponding users.

5. The system (100) as claimed in claim 1, wherein the system (100) utilizes the user's device and location information to detect and avert instances of the identical real ID-based user ‘hash’ usage across multiple accounts, thereby ensuring distinct interactions for each user.

6. A method for ensuring the authenticity and accountability of user interactions within an online social networking platform utilizing real-ID verification, the method (200) comprising the steps of:
a. allowing a user to establish a real-ID during a registration process within an online social networking platform (201);
b. extending to the user an entitlement to participate in one or more engagement activities, subsequent to the establishment of their real-IDs (202);
c. establishing a distinctive user ‘hash’, facilitating an anonymous correlation between the user's real-ID and the associated user profile, thus ensuring confidentiality during correlation establishment (203); and
d. confining the user from employing multiple accounts to engage in the interaction activities within the online social networking platform by interlinking the distinct user ‘hash’ with their real-ID across diverse accounts (204).

7. The method (200) as claimed in claim 6, wherein the unique user ‘hash’ is generated through the utilization of a cryptographic technique, thereby ensuring the security and irreversible correlation between the real-ID and the corresponding user.
